(19) United States
(12) Patent Application Publication
(10) Pub. No.: US 2014/0047322 A1
(43) Pub. Date: Feb. 13, 2014

(54) METHOD AND SYSTEM FOR BROWSING THINGS OF INTERNET OF THINGS ON IP USING WEB PLATFORM

(71) Applicant: KOREA ADVANCED INSTITUTE OF SCIENCE AND TECHNOLOGY, (US)

(72) Inventors: Daeyoung KIM, Daejeon (KR); Ky Nam Giang, Daejeon (KR); Minkeun HA, Daejeon (KR); Kiwoong KWON, Daejeon (KR)

(73) Assignee: KOREA ADVANCED INSTITUTE OF SCIENCE AND TECHNOLOGY, Daejeon (KR)

(21) Appl. No.: 13/785,378

(22) Filed: Mar. 5, 2013

(30) Foreign Application Priority Data
Aug. 9, 2012 (KR) 10-2012-0087055

(51) Int. Cl. G06F 17/22

(52) U.S. Cl. CPC G06F 17/2247
USPC 715/234

(57) ABSTRACT

Provided is a method and system for browsing Internet of Things (IoT) so as to browse resource-limited things with rich UI. The method includes; at a user terminal, recognizing tag information attached to an intelligent thing and confirming an address of a things domain corresponding to the tag information via a dynamic domain name system (DDNS) server; accessing the intelligent thing based on the address of the things domain and acquiring a default web page; at the user terminal, accessing a fixed content provision server and receiving fixed content of the default web page; and, at the user terminal, acquiring dynamic content to be displayed on a web page via the intelligent thing.

### CROSS-REFERENCE TO RELATED APPLICATIONS

This application claims priority under 35 U.S.C. §119 to Korean Patent Application No. 10-2012-0087055, filed on Aug. 9, 2012, in the Korean Intellectual Property Office, the disclosure of which is incorporated herein by reference in its entirety.

### TECHNICAL FIELD

The following disclosure relates to a method and system for enabling a user to browse physical things using a rich user interface (UI) via a web browser in Internet of Things (IoT) such that an end user has rich experience.

### BACKGROUND

Internet of Things (IoT) means the concept that all communicative things are connected to a network so as to perform communication. All systematically recognized objects are classified into things or objects, and include things (or sensor nodes) having a near-field and far-field communication function including radio frequency identification (RFID) and capable of producing and using data, such as sensors, or persons.

The Internet has been rapidly grown due to evolution of IoT and development of Web 2.0 technology. Recently, as an Internet service such as Twitter and Facebook has been extended to a mobile device and thus a mobile web page has been increased, a function for controlling the level of a mobile system is applied to the standard of HTML5. Accordingly, the Internet has been extended to a mobile and embedded device as well as a network for a computer, and a variety of web content is generated and shared by enormous amount of intelligent things (e.g., a radio sensor, an actuator or an embedded device). In such Internet environment, a web platform has attracted attention as a protocol for collecting and sharing information.

The Internet has been used between apparatuses such as computers having sufficient resources. However, in an IoT environment which has been extended to communication between things such as sensors and RFIDs, since data is transmitted and received based on communication between apparatuses having relatively limited resources so as to obtain or control information from the things, there is a need for technology of obtaining information using a minimum amount of resources. Accordingly, in order to implement a web based on things, limit in computation, communication and storage capability are taken into consideration.

Recently, with development of a microprocessor and wireless communication technology, intelligent things of IoT have been substantially developed and current web technologies like HTTP/TCP, HTML or JavaScript are fairly complex and storage consuming to apply into constrained environment and devices. In order to solve these problems, IETF working group Constrained Resource Environment (CoRE) has developed CoAP which is an application protocol supporting resource sharing between end apparatuses based on Representational State Transfer (REST). However, since UDP binding is used, which is not supported currently by most web browsers based on TCP communication.

### SUMMARY

An embodiment of the present disclosure is directed to providing an Internet of Things (IoT) browsing method and system able to always perform web browsing with rich user interface (UI) regardless of resource constraints of things by distributing heavy and static fixed content, which should be provided by resource-limited things, into a network system, downloading and using the fixed content from the network system if necessary, and providing only relatively light and dynamic content.

In one general aspect, a method of browsing Internet of Things (IoT) includes: at a user terminal, recognizing tag information attached to an intelligent thing and confirming an address of a things domain corresponding to the tag information via a dynamic domain name system (DDNS) server; accessing the intelligent thing based on the address of the things domain and acquiring a default web page; at the user terminal, accessing a fixed content provision server and receiving fixed content of the default web page; and, at the user terminal, acquiring dynamic content to be displayed on a web page via the intelligent thing.

The fixed content may include thing-scripts, web templates and frame-scripts.

The receiving the fixed content may include: at the user terminal, receiving thing-script corresponding to the default web page from the fixed content provision server and using the thing-script generating an iframe having a thing's identifier and origin; and, at the user terminal, receiving web template and frame-script from the fixed content provision server using the things' identifier and origin of the iframe.

The receiving the fixed content may further include, at the user terminal, receiving web browser Constrained Application Protocol (CoAP) plug-in installation information from the fixed content provision server and installing a web browser CoAP plug-in under control of the thing-script.

The acquiring the dynamic content may include: at the frame-script, requesting that the thing-script provide real-time information of a thing; at the thing-script, acquiring and providing the real-time information of the thing to the frame-script via the intelligent thing; and, at the frame script, displaying the real-time information of the thing on the web template.

The acquiring and providing the real-time information of the thing to the frame-script via the intelligent thing may include performing CoAP communication with the intelligent thing via a web browser CoAP plug-in and acquiring the real-time information of the thing, if the web browser CoAP plug-in is installed. The acquiring and providing the real-time information of the thing to the frame-script via the intelligent thing may include acquiring the real-time information of the thing provided by the intelligent thing using CoAP protocol via a WSCoAP proxy if there is a WSCoAP proxy available, and acquiring the real-time information of the thing via an XMLHttpRequest object, if the web browser CoAP plug-in is not installed and there is no available WSCoAP proxy.

The thing-script and the frame-script may be hypertext markup language 5 (HTML5) Cross document messaging Application Program Interface (CDM API)-powered JavaScript and transmit and receive a message via the HTML5 CDM API.

In another aspect, a system for browsing Internet of things (IoT) includes: an intelligent thing providing a default web page of a things domain and dynamic content corresponding to the default web page; a fixed content provision server providing fixed content corresponding to the default web page; and a user terminal accessing the intelligent thing to acquire the default web page, acquiring fixed content via the fixed content provision server and acquiring only the dynamic content via the intelligent thing.

The intelligent thing may include: a lightweight web server providing the default web page of the things domain using a hypertext transfer protocol (HTTP); and a Constrained Application Protocol (CoAP) server providing the dynamic content using a CoAP.

The lightweight web server may further include a function for providing the dynamic content instead of the CoAP server, if a web browser is not able to perform CoAP communication.

The user terminal may include a web browser acquiring default web page of the lightweight web server and static content of the fixed content provision server using the HTTP, requesting to provide the static content, and displaying the static content provided in response to the request.

The user terminal may further include a web browser CoAP plug-in acquiring and providing dynamic content provided by the CoAP server to the web browser using the CoAP according to the request of the web browser.

The web browser CoAP plug-in may work as a Netscape Plugin Application Programming Interface (NPAPI) plug-in and an Active-x controller and include a user datagram protocol (UDP) transportation stack and a CoAP client stack.

The web browser may further include a function for accessing the lightweight web server via an XMLHttpRequest object and acquiring the dynamic content if the web browser CoAP plug-in is not available.

The system for browsing IoT may further include: a hypertext markup language 5 (HTML5) WebSocket-based CoAP-CoAP (WSCoAP) proxy supporting CoAP communication with the intelligent thing; and a web application server providing an address of the WSCoAP proxy and a web browser CoAP client supporting communication between the web browser and the WSCoAP proxy to the user terminal accessing a web site while managing the web site providing an IoT service. The address of a WSCoAP proxy can also be provided by the heterogeneous repeater (gateway) to the things and inserted into the thing's homepage so that known to user terminal.

The system for browsing IoT may further include: a JavaScript-based CoAP client called JSCoAP which can consume and construct CoAP messages and manage CoAP transaction. JSCoAP client is included in the thing-script which is downloaded from the provision server

The WSCoAP proxy may include: a UDP socket transmitting and receiving a CoAP message to and from the intelligent thing via a UDP based CoAP; and a web socket transmitting and receiving a WSCoAP packet to and from the user terminal via a HTML5 web socket protocol and performing a message conversion operation between the WSCoAP packet and the CoAP message.

The WSCoAP packet may be a CoAP message with a WSCoAP header having information about a destination address of the CoAP message is attached, and the WSCoAP header may include a length field for storing length information of the destination address and a destination address field for storing the destination address.

The user terminal may include a web browser acquiring a default web page of the lightweight web server and static content of the fixed content provision server using a hypertext transfer protocol (HTTP), communicating with the WSCoAP proxy using the address of the WSCoAP proxy and the web browser CoAP client received from the web site, and acquiring the static content of the intelligent thing.

The fixed content provision server may include: fixed content including a plurality of thing-scripts, web templates and frame-scripts; a thing-script provision unit selecting and downloading thing-script corresponding to the default page to the user terminal; and a template selection unit selecting and providing one of web-template and frame-script based on a thing's identifier and origin acquired by the thing-script downloaded to the user terminal.

The frame-script may request that the thing-script provide real-time information of a thing and display static content received in response to the request on a web template.

The thing-script and the frame-script—may be hypertext markup language 5 (HTML5) Cross document messaging Application Program Interface (CDM API)-powered JavaScript and transmit and receive a message via the HTML5 CDM API.

The fixed content provision server may further include a web browser CoAP plug-in installation unit downloading web browser CoAP plug-in installation information to the user terminal and installing a web browser CoAP plug-in.

According to the present disclosure, a user can always browse physical things with rich user interface (UI) regardless of resource constraints of things by distributing heavy and static fixed content, such as web templates, into a server having sufficient resources and enabling an intelligent thing to process only light and dynamic content such as real-time information of a thing.

In addition, the present disclosure proposes a system for efficiently distributing and managing web content without violating same origin policy (SOP) via a HTML5 Cross Document Messaging API and proposes a web plug-in which interworks with most web browsers such that a web browser of a user terminal communicates with an intelligent thing via a CoAP. A fixed content provision server for storing web templates of things is proposed. The present disclosure supports a PC based web browser and a mobile web browser.

In the present disclosure, it is possible to enhance user experience by enabling a smartphone or another device having an NFC function to tag an NFC tag to obtain a URL of a thing or recognizing QR codes to obtain a URL such that a user browses a thing.

### BRIEF DESCRIPTION OF THE DRAWINGS

The above and other objects, features and advantages of the present disclosure will become apparent from the following description of certain exemplary embodiments given in conjunction with the accompanying drawings, in which:

FIG. 1 is a diagram illustrating an IoT browsing system according to an embodiment of the present disclosure;

FIG. 2 is a diagram showing the configuration of an intelligent thing and a user terminal according to an embodiment of the present disclosure;

FIG. 3 is a diagram showing the configuration of a fixed content provision server according to an embodiment of the present disclosure;

FIG. 4 is a diagram schematically illustrating an IoT browsing method according to an embodiment of the present disclosure;

FIG. 5 is a diagram illustrating Operation S4 of downloading fixed content according to an embodiment of the present disclosure in detail;

FIG. 6 is a diagram illustrating Operation S5 of downloading dynamic content according to an embodiment of the present disclosure in detail;

FIG. 7 is a diagram showing a message transmission/reception method based on HTML5 CDM API;

FIG. 8 is a diagram illustrating an IoT browsing system according to another embodiment of the present disclosure; and

FIG. 9 is a diagram showing a WSCoAP packet according to an embodiment of the present disclosure.

[Detailed Description of Main Elements]

| 1: DDNS server | 2: fixed content provision server |
|---|---|
| 3: heterogeneous network repeater | |
| 4: intelligent thing | |
| 5: user terminal | |

### DETAILED DESCRIPTION OF EMBODIMENTS

Hereinafter, a method and system for browsing IoT based on Internet Protocol (IP) using a web platform and a user terminal using the same according to embodiments of the present disclosure will be described with reference to the accompanying drawings. In the following description, the embodiments are not intended to limit the present disclosure and various modifications are made without departing from the scope of the present disclosure.

In reference numerals of the components of the drawings, the same reference numerals denote the same components in the different drawings. In describing the present disclosure, if it is determined that the detailed description of a related known function or construction renders the scope of the present disclosure unnecessarily ambiguous, the detailed description thereof will be omitted.

The present disclosure relates to a method and system for providing full web experience to an end user by combining the HTML5 web standard and CoAP.

According to the present disclosure, an end user can directly browse and control an intelligent thing with constrained resources using rich user interface (UI).

In the present disclosure, it is possible to save network load and physical resources in things with constrained resources. Fixed content configuring a rich web interface, such as web templates, multimedia, frame-scripts (or application codes) or thing-scripts, is stored in a dedicated server such as a fixed content provision server. Then, communication with an intelligent thing is performed via CoAP using an Ajax XMLHttpRequest object or a web browser CoAP plug-in as thing-script and real-time data is dynamically obtained from things and is displayed on the web. Thus, the physical things including rich UI may be directly browsed by a user and thus user experience may be remarkably increased.

End users who use smartphones may easily acquire things domain name for browsing via tags such as NFC and QR codes and easily interact with physical things. In the present disclosure, a web browser plug-in having high compatibility is developed such that all web browsers directly interwork with an intelligent thing via a CoAP.

In the present disclosure, since a resource distribution structure for separating fixed content and dynamic real-time data of things is employed, it is possible to cope with cross-domain communication using HTML5 Cross Document Messaging API.

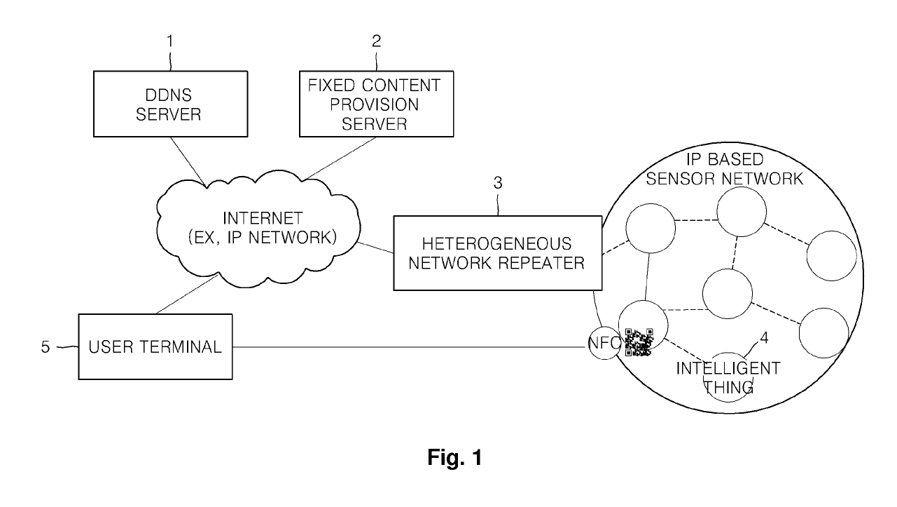

FIG. 1 is a diagram illustrating an IoT browsing system according to an embodiment of the present disclosure

As shown in FIG. 1, the system of the present disclosure may include a dynamic DNS (DDNS) server 1, a fixed content provision server 2, a heterogeneous network repeater 3, an intelligent thing 4, and a user terminal 5.

The DDNS server 1 and the fixed content provision server 2 support mobility of the intelligent thing and provide presentation metadata of the intelligent thing 4 that shapes thing's rich web interface when browsing the thing.

That is, the DDNS server 1 acquires an IP address corresponding to a things domain corresponding to NFC tags or QR codes attached to the thing, that is, the address of a lightweight web server in which thing is embed, and informs the user terminal 5 of the IP address.

The fixed content provision server 2 distributes and provides heavy and static content which should be provided by the intelligent thing 4 and stores, manages and provides fixed web content commonly applied to a web page of the thing to the user terminal 5 as necessary. At this time, the fixed web content may include web templates for providing rich UI of the thing, frame-scripts for requesting to provide real-time information of the thing and displaying the real-time information, and thing-scripts for receiving the web templates and the frame-scripts from the fixed content provision server 2 and acquiring real-time information of the thing.

The heterogeneous network gateway 3 connects an IP based sensor network composed of intelligent thing 4 and the existing Internet (e.g., an IP network), which are heterogeneous networks, to each other such that the intelligent thing 4 is connected to the Internet. That is, the heterogeneous network gateway 3 specifies the intelligent thing 4 based on the IP address, performs compression in order to transmit a HTTP, TCP, UDP and IP header used to perform communication to the intelligent thing 4 (that is, a sensor network) when receiving a request for communication of the user terminal 5, and performs decompression in order to transmit a response from the intelligent thing 4 to the user terminal 5 over the Internet.

The intelligent thing 4 may serve as a sensor node configuring the IP based sensor network and include at least one of a sensor and an actuator so as to collect and provide real-time information of the thing or control operation of the thing. In particular, the intelligent thing 4 includes a lightweight web server and a Constrained Application Protocol (CoAP) server, provides a default web page of a things domain to the user terminal 5 via a hypertext transfer protocol (HTTP) and provides real-time information of the thing to the user terminal via a CoAP.

The user terminal 5 includes a smartphone, a tablet PC, a desktop, etc. and is a user input pointer for searching for IoT, which supports HTTP and web browser CoAP plug-in, supports communication with the DDNS server 1, the fixed content provision server 2 and the lightweight web server of the intelligent thing 4, and supports communication with the CoAP server via a CoAP.

That is, the user terminal 5 further supports a CoAP developed to be used in a resource-limited environment and acquires real-time information of the thing, thereby performing data communication optimized for the resource-limited environment.

The IoT browsing system of the present disclosure distributes heavy and static content which should be provided by the intelligent thing with limited resources into the fixed content provision server and enables the intelligent thing to provide only relatively light and dynamic content to the user terminal via the CoAP such that the user terminal 5 always performs web browsing with rich UI regardless of resource constraints of the intelligent thing.

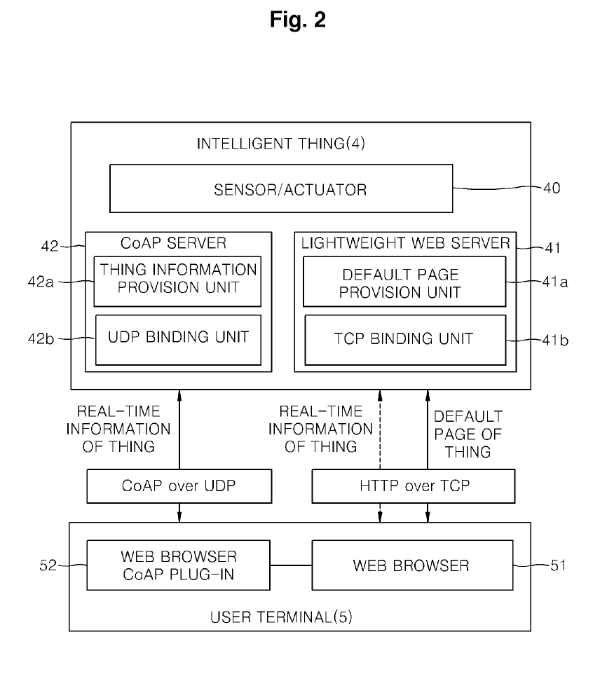

FIG. 2 is a diagram showing the configuration of the intelligent thing 4 and the user terminal 5 according to an embodiment of the present disclosure.

As shown in FIG. 2, the intelligent thing 4 of the present disclosure may include a sensor or an actuator 40, a lightweight web server 41 and a CoAP server 42.

The sensor or actuator 40 collects and provides environment sensing data such as a temperature and humidity of a place where the thing is located and real-time information of the thing such as status information of the thing and controls operation of thing.

The lightweight web server 41 includes a default web page provision unit 41a for storing and providing information about a default web page and a Transmission Control Protocol (TCP) binding unit 41b for performing TCP binding and provides a default web page of a things domain via a TCP. That is, the lightweight web server 41 provides the default web page of the things domain using TCP binding and serves as an entry point for thing browsing.

If the user terminal 5 does not support CoAP, the lightweight web server 41 may provide real-time information of the thing instead of the CoAP server 42.

The lightweight web server 41 uses the TCP and the HTTP. These protocols are too heavy to be used in an embedded system of a limited environment such as a sensor network, and thus require header compression.

In contrast, the CoAP server 42 includes a thing information provision unit 42a for providing real-time information of the thing to the user terminal 5 and a user datagram protocol (UDP) binding unit 42b for performing UDP binding and provides real-time information of the thing to the user terminal 5 via a UDP based CoAP.

Since the CoAP server 42 exchanges data using UDP binding and the CoAP developed to use a resource-limited system unlike the lightweight web server 41, separate header compression is not required.

For reference, UDP binding should be used in order to exchange data via a CoAP. However, UDP binding is not supported by most web browsers so that most web browsers cannot run CoAP. However, it is predicted that UDP binding will be implemented in modern web browsers in near future as the need of native audio/video and real-time web application is rising.

Accordingly, the present disclosure proposes a web browser plug-in that is compatible with most popular web browsers which run a CoAP client. The user terminal 5 further includes a web browser CoAP plug-in 52 in addition to the existing web browser 51.

The web browser 51 supports a TCP based HTTP, confirms the address of a things domain via the DDNS server 1, accesses the lightweight web server 41 using the things domain address, receives a default web page (HTTP), and receives a variety of fixed content (that is, thing-scripts, web templates, frame-scripts, etc.) corresponding to the default web page (HTTP) via the fixed content provision server 2. That is, the web browser 51 serves to receive heavy and static content.

The web browser CoAP plug-in 52 accesses the CoAP 42 of the thing via UDP binding to receive real-time information of the thing and provides the information to the web browser 51. That is, the web browser CoAP plug-in 52 receives relatively light and dynamic content via the CoAP and sends the content to the web browser 51.

The web browser CoAP plug-in 52 works as a Netscape Plugin Application Programming Interface (NPAPI) plug-in for Firefox, Chrome, Safari or an Opera web browser and an Active-x controller for an Internet Explorer browser family. It consists of two protocol stacks, that is, a UDP transportation stack and a CoAP client stack.

CoAP plug-in interfaces with JavaScript via one function sendRequest (String: request_type, String: resource_path) and one event listener receive (int: status code, String: content) that listen for on Receive event when requested data is available. In addition, for security reasons, CoAP plug-in conforms to Same Origin Policy (SOP) does not allow cross-origins JavaScript requests to be performed.

If the user terminal may not use the web browser CoAP plug-in (e.g., if the user rejects installation of the web browser CoAP plug-in), the web browser 51 communicates the lightweight web server 41 of the thing 4 via an Ajax XMLHttpRequest object instead of the web browser CoAP plug-in so as to provide default resources of the thing and real-time information of the thing.

In this case, the web browser 51 of the present disclosure may receive web content distributed into the fixed content provision server 2 and the intelligent thing 4 so as to generate SOP problems. At this time, the SOP problems are solved using HTML Cross document messaging Application Program Interface (DM API) which is a communication API for exchanging a message between web pages.

First, the HTML5 CDM API is part of HTML5 and is going to be standardized, meaning officially accepted and widely spread, thus it ensures interoperability. Second, it does not need to cooperate between thing's lightweight web server and the fixed content provision server which should be maximally avoided because it permanently limits thing's information to be only retrieved from the domain of the fixed content provision server. Finally, it does not require user's permission to perform cross-domain requests, which result in better browsing experiences.

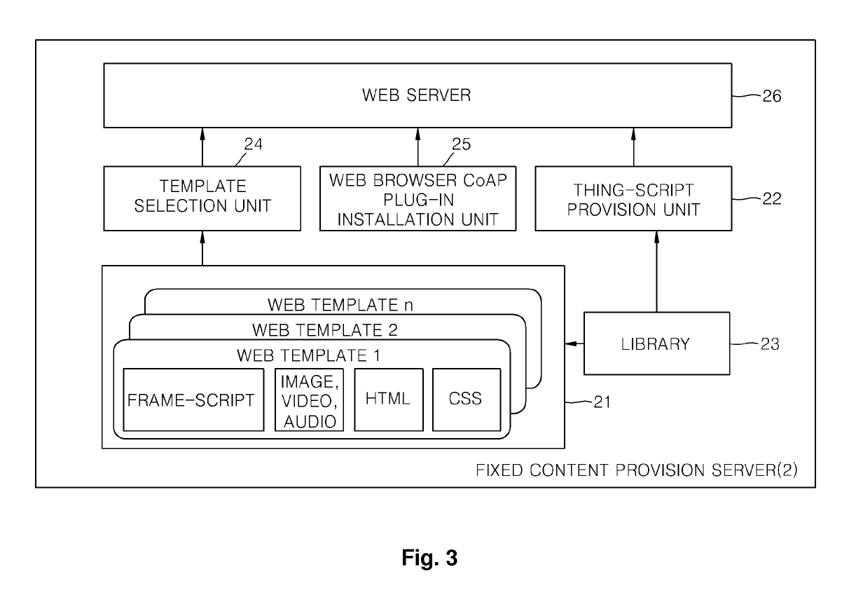

FIG. 3 is a diagram showing the configuration of the fixed content provision server 2 according to an embodiment of the present disclosure.

As shown in FIG. 3, the fixed content provision server 4 of the present disclosure includes a plurality of web templates 21, a thing-script provision unit 22, a library 23, and a template selection unit 24, a web browser CoAP plug-in installation unit 25 and a web server 26.

The plurality of web templates 21 respectively corresponds to a plurality of things, provides rich UI of things, and includes frame-scripts for communicating with thing-scripts to request to provide real-time information of the thing and displaying the information on a web template, multimedia content such as audio/video/image, Hypertext Markup Language (HTML) and cascading style sheets (CSS) defining the style of the web document.

The thing script provision unit 22 includes thing-scripts corresponding to things and selects and downloads a thing script corresponding to a default page acquired by the user terminal 5 according to the request of the user terminal.

At this time, the thing script is downloaded to the web browser 51 of the user terminal 5 such that the user terminal 5 confirms an identifier (e.g., electronic product code (EPC)) and origin of a specific thing and receives a web template corresponding to the specific thing from the fixed content provision server 4. The thing identifier is used when a correct web template for the thing is selected and the origin of the thing is used when communicating with the thing-script.

The thing script communicates with the thing 4 via the web browser CoAP plug-in so as to acquire real-time information of the thing. If the web browser CoAP plug-in is not installed in the user terminal 5, communication with the thing is performed via a WSCoAP proxy using a JSCoAP client and lastly if a WSCoAP proxy is not available, the communication is performed via an Ajax XMLHttpRequest of HTTP so as to acquire real-time information of the thing.

The library 23 provides an application programming interface (API) of a personal hypertext preprocessor (PHP) and JavaScript for a specific application.

When the user terminal 5 sends the identifier and origin of the thing and requests to provide a web template and a frame-script, the template selection unit 24 retrieves a plurality of web templates 21 based on the identifier and origin of the thing and acquires and provides a web template and a frame-script requested by the user terminal to the user terminal 5.

The web browser CoAP plug-in installation unit 25 includes web browser CoAP plug-in installation information and provides the web browser CoAP plug-in installation information to the user terminal 5 such that the web browser CoAP plug-in is installed in the user terminal 5.

The web server 26 supports communication with the user terminal 5 using a TCP HTTP.

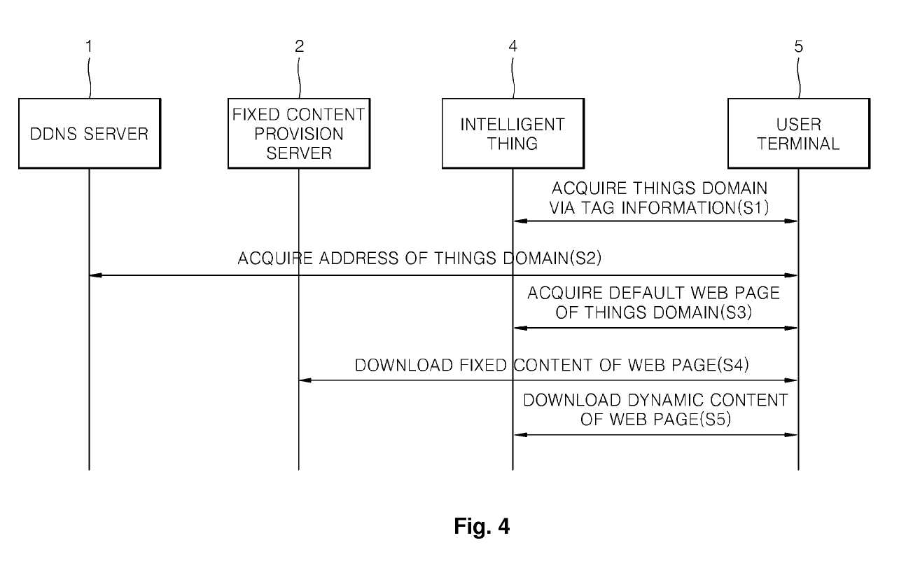

FIG. 4 is a diagram schematically illustrating an IoT browsing method according to an embodiment of the present disclosure.

First, a user reads NFC tags or QR codes attached to the intelligent thing 4 and acquires a things domain via the user terminal for web browsing via things (S1). At this time, if the user terminal is a smartphone, a thing URL encoded in the QR codes or the NFC tags is recognized using a phone camera or NFC and, if the user terminal is a desktop, a ting URL is retrieved from a thing catalog or a manual device or is retrieved and used from a thing's surface.

Operation S1 will be performed when the user knows the things domain but wishes to easily browse a close thing or when the user does not know a things domain and will be omitted when the user knows a domain name similarly use of the Internet.

The user terminal 5 accesses DDNS server 1 via the web browser 51 and confirms the IP address of the things domain, that is, the IP address of the lightweight web server 41 installed in the thing (S2).

Then, the user terminal 5 accesses the lightweight server 41 and acquires a default web page provided by the lightweight web server 41 of the thing, if the web browser installed in the thing may not perform CoAP communication based on the IP address of the things domain via the web browser 51 (S3).

The default web page of the present disclosure serves as an entry point for thing browsing and may be provided via the following procedure. For example, if the web browser 51 of the user terminal 5 transmits a default web page request message to the lightweight web server 41 of the thing, this message is protocol-compressed via the heterogeneous network repeater 3 and is sent to the sensor network to reach a destination thing (that is, a destination) in a multi-hop network fashion and the destination thing may provide a default web page to the user terminal 5 in response thereto.

In addition, the default web page includes two HTML elements: one is JavaScript element, a source of which is a thing-script which is a JavaScript file located in the fixed content provision server 2 and the other is an Electronic Product Code of the thing. Unique thing-scripts are present in the things and are distinguished via the EPC of the things.

Then, the user terminal 5 accesses the fixed content provision server 2 and downloads fixed content (thing-script, web template, frame-script, etc.) corresponding to the default web page acquired in S3. That is, the user terminal 5 of the present disclosure downloads the fixed content for providing a web page including rich UI from the fixed content provision server 2 instead of the intelligent thing 4 (S4). In this case, since only small dynamic content such as real-time information of the intelligent thing 4 is processed, it is possible to implement rich UI using the resource-limited thing.

Then, the thing-script of the user terminal 5 acquires real-time information of the thing provided by the CoAP server installed in the intelligent thing 4 via the web browser CoAP plug-in according to the request of the frame-script and the frame-script displays the real-time information of the thing acquired through the thing-script on the web template (S5).

However, if the web browser CoAP plug-in may not be used in S5, the thing-script checks for a presence of a WSCoAP proxy and use JSCoAP client to communicate with thing's CoAP server via the WSCoAP proxy if available. In the worst case where there is no WSCoAP proxy available, the thing-script retrieves the XMLHttpRequest object for performing communication with the lightweight web server 41 instead and acquires the real-time information of the thing provided by the lightweight web server 41 installed in the intelligent thing. That is, in the present disclosure, even when the user terminal 5 may not use the web browser CoAP plug-in due to various environment factors, and WSCoAP proxy may not be available, it is possible to acquire the real-time information of the thing so as to ensure operation reliability.

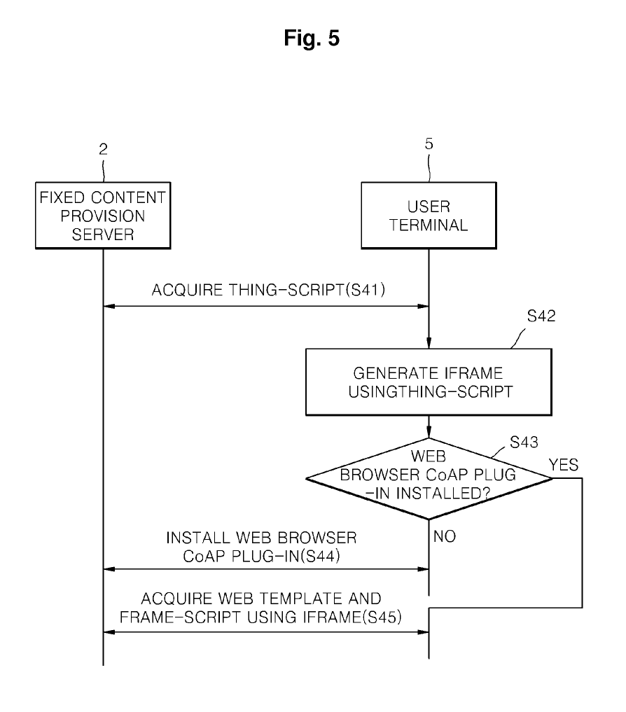

FIG. 5 is a diagram illustrating Operation S4 of downloading fixed content according to an embodiment of the present disclosure in detail.

First, the web browser 51 of the user terminal 5 downloads the thing-script from the fixed content provision server 2 using a thing's identifier included in the default web page of the thing as a key (S41).

Then, a transparent iframe of which “src” property points to a template selection unit 24 of the fixed content provision server 2 with two query parameters, that is, a thing's identifier and thing's origin, is generated using the thing-script (S42). The thing's identifier is used when a correct web template for the thing is selected and the thing's origin is used when communicating with the thing-script.

Then, the web browser 51 checks system registry to know which library is used to handle object type Application/x-jscoap (either npJSCoAP.dll for Windows or npJSCoAP.so for Linux) (S43).

If the web browser CoAP plug-in is not installed yet, which means there is no library that handles the Application/x-jscoap object, thing-script enables user to download and install required plug-in from the fixed content provision server 2 to generate an application/x-jscoap type object having coap as a plug-in identifier of the web browser CoAP plug-in (S44). If the user refuses to install JSCoAP, it will look up in the thing's homepage to find a WSCoAP proxy's address. If a WSCoAP proxy is found available, it uses the JSCoAP client to communicate with the thing's CoAP server via the WSCoAP proxy. If there is also no available WSCoAP proxy, it will fall back to use Ajax XMLHttpRequest over HTTP for retrieving the real-time information of the thing.

Then, the web browser 51 acquires a web template and frame-script corresponding to the default web page from the fixed content provision server 2 using two query parameters included in the iframe (S45). At this time, the web template serves to provide rich UI of the thing to an end user, and the frame-script may communicate with the thing-script and acquire the real-time information of the thing to be displayed on the iframe. The frame-script is hereinafter referred to as in order to be differentiated from the thing-script.

Since the iframe of the present disclosure is designed to be transparently appeared to end users, the end users do not recognize the iframe and experience a web interface which comes directly from the thing.

The thing-script and the frame-script are JavaScript and perform communication based on the above-described HTML5 CDM API so as to solve the SOP problems. Accordingly, the iframe is used to display rich UI and to communicate with the thing-script in order to retrieve the real-time information of the thing.

In the present disclosure, a separate server such as the fixed content provision server 2 is included to provide fixed content which has been provided by the thing. As a result, the user may always receive rich UI regardless of the resource-limited environment of the thing.

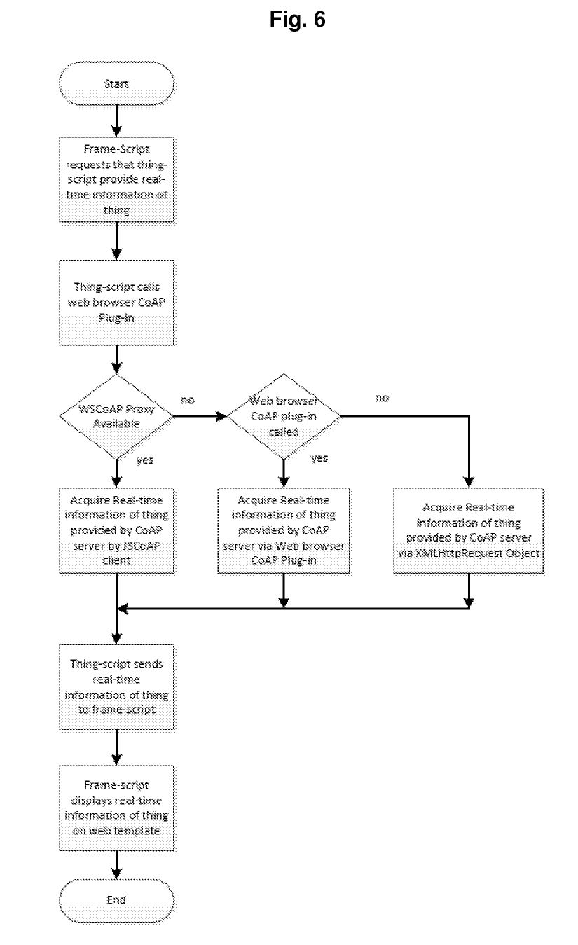

FIG. 6 is a diagram illustrating Operation S5 of downloading dynamic content according to an embodiment of the present disclosure in detail.

First, when real-time information of the things is necessary, the frame-script requests that the thing-script provide information (S51).

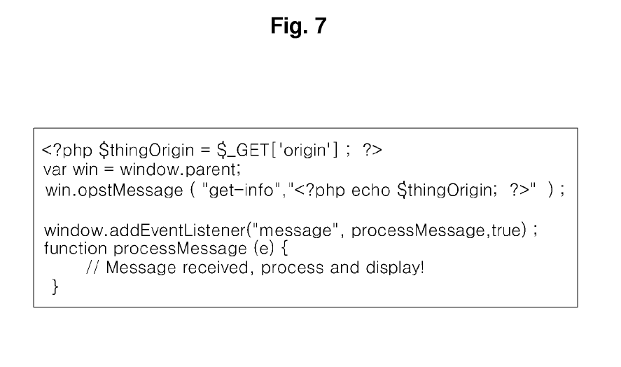

At this time, the frame-script and the thing-script communicate based on HTML5 CDM API, which conforms to a message transmission and reception method of FIG. 7. Referring to FIG. 7, a post message method of HTML5 CDM API receives two input parameters including a message to be sent (get-info) and target's origin. The message to be sent (get-info) is a message for requesting real-time information of the thing and the target's origin (the thing's origin) includes a protocol scheme and a domain name in order to indicate the target's origin. In order to receive the HTML5 CDM API message, the receiver adds an on Message event listener on a JavaScript Window object to verify the origin of the message before processing the received data.

The thing-script which receives an information provision request message of the frame-script in Operation S1 calls the web browser CoAP plug-in (S52) and acquires the real-time information of the thing from the CoAP server 42 of the thing 4 via the web browser CoAP plug-in 52 (S53).

Then, the thing-script sends the real-time information of the thing to the frame-script (S55) and the frame-script displays the real-time information of the thing on the rich UI of the web template (S56).

However, if the web browser CoAP plug-in 52 is not available, and a WSCoAP proxy is available, the thing-script uses its JSCoAP client to communicate with the thing's CoAP server via the WSCoAP proxy to retrieve thing's information. If there is no CoAP plug-in as well as WSCoAP proxy, the thing-script requests that the lightweight web server 41 provide the real-time information of the thing via the XMLHttpRequest object instead of the CoAP server 42 and acquires the real-time information of the thing provided by the lightweight web server 41 (S55).

For reference, the thing-script is downloaded from the fixed content provision server 2, but a JavaScript source does need to be present in the same server and thus may come from a things domain. Accordingly, the thing-script may request the information of the thing from the things domain, instead of the frame-script.

In the present disclosure, it is possible to prevent unnecessary network load from being generated by performing communication with the thing 4 using the CoAP optimized for the resource-limited environment and acquiring the real-time information of the thing to be displayed on the web page and to ensure reliability of a network system by replacing the CoAP with the XMLHttpRequest object if the CoAP is not available.

In the present disclosure, a proxy apparatus for enabling a network apparatus other than the user terminal 5 to support CoAP communication is proposed such that the web browser of the user terminal 5 performs communication using the CoAP if the web browser CoAP plug-in 52 is not installed in the user terminal 5.

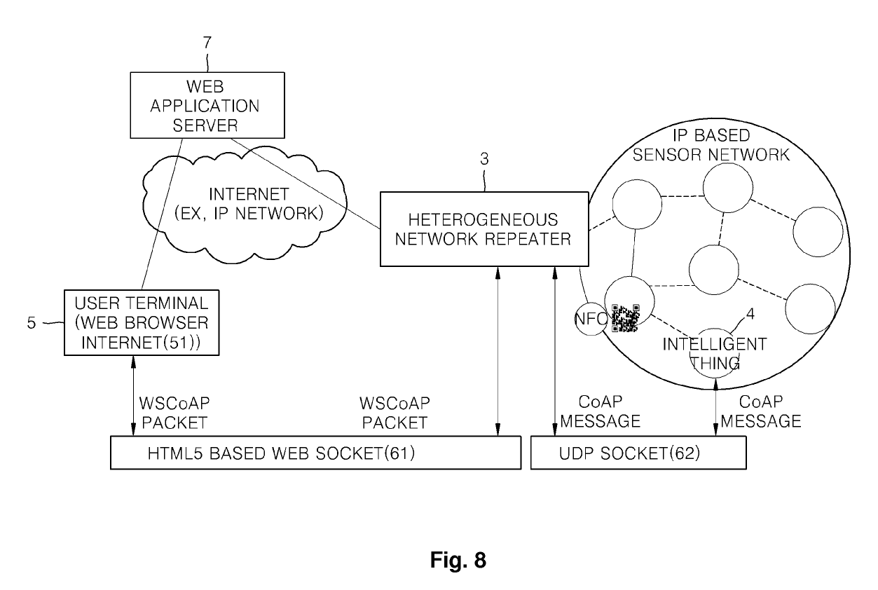

FIG. 8 is a diagram illustrating an IoT browsing system according to another embodiment of the present disclosure.

As shown in FIG. 8, the IoT browsing system according to another embodiment of the present disclosure includes a network apparatus other than the user terminal 5. The IoT browsing system may further include a HTML5 WebSocket-based CoAP-CoAP (WSCoAP) proxy 6 for enabling the web browser of the user terminal 5 to collect dynamic content of the intelligent thing 4 while directly performing CoAP communication with the intelligent thing 4, and a web application server 7 for providing the address of the WSCoAP proxy 6 when the user terminal 5 accesses a web site while managing the web site for providing a IoT service, downloading a web browser CoAP client communicating with the WSCoAP proxy 6 to the web browser 51 of the user terminal 5, and enabling the web browser 51 to perform CoAP communication with the intelligent thing via the WSCoAP proxy 6.

The WSCoAP proxy 6 is a CoAP-CoAP proxy based on HTML5 webSocket and may include a web socket 61 and a UDP socket 62. The web socket 61 performs a conversion operation between a WSCoAP packet and a CoAP message while transmitting and receiving the WSCoAP packet to and from the user terminal 5 via a HTML5 based web socket protocol, and the UDP socket 62 transmits and receives the CoAP message to and from the intelligent thing 4 according to a UDP based CoAP.

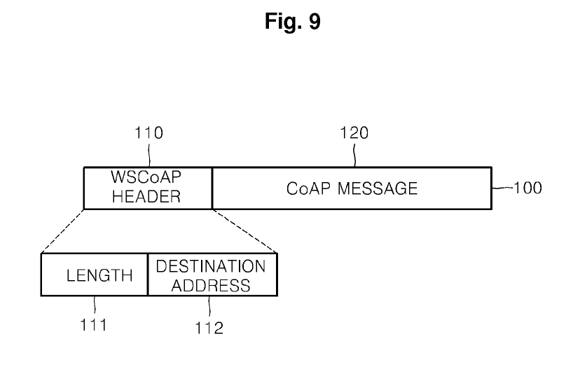

For reference, the WSCoAP packet of the present disclosure includes a WSCoAP header 110 and a CoAP message 120 as shown in FIG. 9. The WSCoAP header 110 is attached to the beginning of the CoAP message 110 to indicate information about a destination address of the CoAP message and includes a length field 111 having information about a destination address length and a destination address field 112 having information about a destination address.

When the WSCoAP proxy 6 receives a WSCoAP packet from the web browser 51 of the user terminal 5, the web socket 61 reads the WSCoAP header 110 of the received WSCoAP packet 100 to confirm a transmission destination of the CoAP message and removes the WSCoAP header 110 inserted into the WSCoAP packet 100 to acquire the CoAP message. Then, the CoAP message is sent to the intelligent thing 4 corresponding to the transmission destination via the UDP socket 62. As a result, the user terminal 5 enables the web browser 51 to perform CoAP communication with the intelligent thing 4 instead of the web browser CoAP plug-in 52.

The WSCoAP proxy 6 of the present disclosure may be included in various network apparatuses, but is preferably located at a network edge of a UDP protocol. That is, the WSCoAP proxy 6 is most preferably included in a network apparatus corresponding to a destination sensor node, such as the heterogeneous network repeater 3.

The address of the WSCoAP proxy 6 or the network apparatus including the WSCoAP proxy 6 is previously acquired by the web application server which manages the web site for providing the IoT service or does not need to be indicated or previous configured by a web client. In addition, the WSCoAP proxy's address can also be acquired by user terminal's web browser as follow: the address is given to the thing by the heterogeneous repeater during association process and it is inserted into the thing's homepage so that known to user terminal's web browser directly.

In the case that an additional intermediate web application server is deployed to provide thing service and application to end user instead of direct browsing the thing: when the user terminal 5 accesses the web site of the web application server 7, a JSCoAP client is downloaded that supporting communication between the web browser 51 and the WSCoAP proxy 6 to the web browser 51 of the user terminal 5, and the web browser 51 communicates with the CoAP server 42 of the intelligent thing 4 via the WSCoAP proxy 6.

The web application server 7 does not need to implement a CoAP engine for utilizing thing's resources in the web application thereof. Since a HTML5 based web socket protocol is asynchronous and bi-directional, the basic function of the CoAP is supported and the CoAP function is provided on the web.

In the present disclosure, the proxy apparatus supporting CoAP communication of the user terminal 5 is proposed instead of the user terminal 5 such that the user terminal 5 performs communication using the CoAP even when the web browser CoAP plug-in 52 is not installed in the user terminal 5.

Referring to the above-described embodiments, the IoT browsing system of the present disclosure supporting CoAP communication between the intelligent thing and the user terminal may be configured in various forms. As described, the CoAP communication method between the intelligent thing and the user terminal may be variously changed according to the implementations of the IoT browsing system.

(a) If the WSCoAP proxy 6 corresponding to the intelligent thing 4 is present, the user terminal 5 collects dynamic content of the intelligent thing 4 while performing CoAP communication with the intelligent thing 4 via the WSCoAP proxy 6 using JSCoAP client.

(b) If the WSCoAP proxy 6 corresponding to the intelligent thing 4 is not present and the web browser CoAP plug-in 51 is installed in the user terminal 5, the user terminal 5 collects dynamic content of the intelligent thing 4 with CoAP communication via the web browser CoAP plug-in 51.

(c) If the WSCoAP proxy 6 corresponding to the intelligent thing 4 is not present and the web browser CoAP plug-in 51 is not installed in the user terminal 5, dynamic content is collected from the lightweight web server via the XMLHttpRequest object.

While the present disclosure has been described with respect to the specific embodiments, it will be apparent to those skilled in the art that various changes and modifications may be made without departing from the spirit and scope of the disclosure as defined in the following claims.

What is claimed is:

1. A method of browsing Internet of Things (IoT) comprising:
at a user terminal, recognizing tag information attached to an intelligent thing and confirming an address of a things domain corresponding to the tag information via a dynamic domain name system (DDNS) server;
accessing the intelligent thing based on the address of the things domain and acquiring a default web page;
at the user terminal, accessing a fixed content provision server and receiving fixed content of the default web page; and
at the user terminal, acquiring dynamic content to be displayed on a web page via the intelligent thing.

2. The method of browsing IoT according to claim 1, wherein the fixed content include thing-scripts, web templates and frame-scripts.

3. The method of browsing IoT according to claim 2, wherein said receiving the fixed content includes:
at the user terminal, receiving thing-script corresponding to the default web page from the fixed content provision server and generating an iframe having a thing's identifier and origin; and
at the user terminal, receiving web template and frame-script from the fixed content provision server using the things' identifier and origin of the iframe.

4. The method of browsing IoT according to claim 3, wherein said receiving the fixed content further includes, at the user terminal, receiving web browser Constrained Application Protocol (CoAP) plug-in installation information from the fixed content provision server and installing a web browser CoAP plug-in under control of the thing-script.

5. The method of browsing IoT according to claim 2, wherein said acquiring the dynamic content includes:
at the frame-script, requesting that the thing-script provide real-time information of a thing;
at the thing-script, acquiring and providing the real-time information of the thing to the frame-script via the intelligent thing; and
at the frame script, displaying the real-time information of the thing on the web template.

6. The method of browsing IoT according to claim 5, wherein said acquiring and providing the real-time information of the thing to the frame-script via the intelligent thing includes:
at the user terminal, performing CoAP communication with the intelligent thing via a hypertext markup language 5 (HTML5) WebSocket-based CoAP-CoAP (WSCoAP) proxy and acquiring the real-time information of the thing, if the WSCoAP proxy corresponding to the intelligent thing is present.

7. The method of browsing IoT according to claim 5, wherein said acquiring and providing the real-time information of the thing to the frame-script via the intelligent thing includes:
at the user terminal, performing CoAP communication with the intelligent thing via a web browser CoAP plug-in and acquiring the real-time information of the thing, if a hypertext markup language 5 (HTML5) WebSocket-based CoAP-CoAP (WSCoAP) proxy corresponding to the intelligent thing is not present and the web browser CoAP plug-in is installed.

8. The method of browsing IoT according to claim 5, wherein said acquiring and providing the real-time information of the thing to the frame-script via the intelligent thing includes:
at the user terminal, acquiring the real-time information of the thing provided by the intelligent thing via an XMLHttpRequest object, if a hypertext markup language 5 (HTML5) WebSocket-based CoAP-CoAP (WSCoAP) proxy corresponding to the intelligent thing is not present and the web browser CoAP plug-in is not installed.

9. The method of browsing IoT according to claim 5, wherein the thing-script and the frame-script are hypertext markup language 5 (HTML5) Cross document messaging Application Program Interface (CDM API)-powered JavaScript and transmits and receives a message via the HTML5 CDM API.

10. A system for browsing Internet of things (IoT) comprising:
an intelligent thing providing a default web page of a things domain and dynamic content corresponding to the default web page;
a fixed content provision server providing fixed content corresponding to the default web page; and
a user terminal accessing the intelligent thing to acquire the default web page, acquiring fixed content via the fixed content provision server and acquiring only the dynamic content via the intelligent thing.

11. The system for browsing IoT according to claim 10, wherein the intelligent thing includes:
a lightweight web server providing the default web page of the things domain using a hypertext transfer protocol (HTTP); and
a Constrained Application Protocol (CoAP) server providing the dynamic content using a CoAP.

12. The system for browsing IoT according to claim 11, wherein the lightweight web server further includes a function for providing the dynamic content instead of the CoAP server, if a web browser is not able to perform CoAP communication.

13. The system for browsing IoT according to claim 11, wherein the user terminal includes a web browser acquiring default web page of the lightweight web server and static content of the fixed content provision server using the HTTP, requesting to provide the static content, and displaying the static content provided in response to the request.

14. The system for browsing IoT according to claim 11, wherein the user terminal further includes a web browser CoAP plug-in acquiring and providing dynamic content provided by the CoAP server to the web browser using the CoAP according to the request of the web browser.

15. The system for browsing IoT according to claim 14, wherein the web browser CoAP plug-in works as a Netscape Plugin Application Programming Interface (NPAPI) plug-in and an Active-x controller and includes a user datagram protocol (UDP) transportation stack and a CoAP client stack.

16. The system for browsing IoT according to claim 14, wherein the web browser further includes a function for accessing the lightweight web server via an XMLHttpRequest object and acquiring the dynamic content if the web browser CoAP plug-in is not available.

17. The system for browsing IoT according to claim 10, further comprising:
a hypertext markup language 5 (HTML5) WebSocket-based CoAP-CoAP (WSCoAP) proxy supporting CoAP communication with the intelligent thing; and
a web application server providing an address of the WSCoAP proxy and a web browser CoAP client supporting communication between the web browser and the WSCoAP proxy to the user terminal accessing a web site while managing the web site providing an IoT service.
A heterogeneous repeater (the gateway) providing an address of the WSCoAP proxy to the thing and the thing inserting the address into its own homepage therefore knowing directly to user terminal's web browser.

18. The system for browsing IoT according to claim 17, wherein the WSCoAP proxy includes:
a UDP socket transmitting and receiving a CoAP message to and from the intelligent thing via a UDP based CoAP; and
a web socket transmitting and receiving a WSCoAP packet to and from the user terminal via a HTML5 web socket protocol and performing a message conversion operation between the WSCoAP packet and the CoAP message.

19. The system for browsing IoT according to claim 18, wherein the WSCoAP packet is a CoAP message in which a WSCoAP header having information about a destination address of the CoAP message is inserted, and the WSCoAP header includes a length field for storing length information of the destination address and a destination address field for storing the destination address.

20. The system for browsing IoT according to claim 17, wherein the user terminal includes a web browser acquiring a default web page of the lightweight web server and static content of the fixed content provision server using a hypertext transfer protocol (HTTP), communicating with the WSCoAP proxy using the address of the WSCoAP proxy and the web browser CoAP client received from the web site, and acquiring the static content of the intelligent thing.

21. The system for browsing IoT according to claim 10, wherein the fixed content provision server includes:
fixed content including a plurality of thing-scripts, web templates and frame-scripts;
a thing-script provision unit selecting and downloading thing-script corresponding to the default page to the user terminal; and
a template selection unit selecting and providing one of web-template and frame-script based on a thing's identifier and origin acquired by the thing-script downloaded to the user terminal.

22. The system for browsing IoT according to claim 10, wherein the frame-script requests that the thing-script provide real-time information of a thing and displays static content received in response to the request on a web template.

23. The system for browsing IoT according to claim 22, wherein the thing-script and the frame-script are hypertext markup language 5 (HTML5) Cross document messaging Application Program Interface (CDM API)-powered JavaScript and transmits and receives a message via the HTML5 CDM API.

24. The system for browsing IoT according to claim 21, wherein the fixed content provision server further includes a web browser CoAP plug-in installation unit downloading web browser CoAP plug-in installation information to the user terminal and installing a web browser CoAP plug-in.
